(19) United States
(12) Patent Application Publication
(10) Pub. No.: US 2017/0156525 A1
(43) Pub. Date: Jun. 8, 2017

(54) Duckbill Valve Arrangement For A Beverage Dispensing Container

(71) Applicant: Pernod Ricard SA, Paris (FR)

(72) Inventors: Ian Allan GUY, Paris (FR); Sarah Helen LIDDELL, Paris (FR); Steven John KELLY, Paris (FR); James Ashley GADD, Paris (FR); Tom FORAN, Paris (FR); Stephen Philip DE SAULLES, Paris (FR)

(21) Appl. No.: 15/321,521

(22) PCT Filed: Jun. 23, 2015
(86) PCT No.: PCT/EP2015/064071

§ 371 Date: Dec. 22, 2016

(30) Foreign Application Priority Data
Jun. 23, 2014 (GB) 1411147.0

(51) Int. Cl. A47G 19/22; B65D 47/20; A47G 21/18; F16K 15/14

(52) U.S. Cl. CPC A47G 19/2266; F16K 15/147; B65D 47/2031; A47G 21/185

(57) ABSTRACT

This invention is directed to a duckbill valve arrangement (10) for a beverage dispensing container (70). The arrangement (10) includes a tube (11) having a resilient tube wall (12) with an outer surface (15) and defining an internal passageway (13). The arrangement (10) further includes a duckbill valve (30) mounted within the passageway (13). The duckbill valve (30) includes a resiliently closable valve mouth (41) arranged to be opened upon compression of the tube (11). At least one groove (20, 21) extends along the outer surface (15) of the tube wall (12) for reducing the force required to compress the tube (11) and open the duckbill valve (30).

### TECHNICAL FIELD

This invention is directed towards duckbill valve arrangements and particularly those for use in beverage dispensing containers.

### BACKGROUND

Duckbill valves are widely used one-way valves for controlling fluid flow in a variety of fluid systems. They typically comprise a pair of resilient lips extending from a cylindrical body and defining a valve opening. Fluid in between the lips provides an internal pressure to the valve and fluid on the outer surfaces of the lips provides an external pressure to the valve. When the external pressure is greater than the internal pressure the valve opening is sealed in a closed position. When the internal pressure is greater than a cracking pressure, being the internal pressure required to overcome the force exerted by the external pressure, fluid will be able to flow through the valve. As a result, duckbill valves are commonly used as check valves to prevent backflow and the like in fluid systems.

However, duckbill valves are not commonly used in beverage dispensing containers. The present invention is directed to duckbill valves suitable for use in beverage dispensing containers.

### SUMMARY

The present invention therefore provides a duckbill valve arrangement for a beverage dispensing container, the arrangement comprising: a tube comprising a resilient tube wall having an outer surface and defining an internal passageway; and a duckbill valve mounted within the passageway, the duckbill valve comprising a resiliently closable valve mouth arranged to be opened upon compression of the tube; wherein at least one groove extends along the outer surface of the tube wall for reducing the force required to compress the tube and open the duckbill valve.

The present invention further provides a duckbill valve arrangement for a beverage dispensing container, the arrangement comprising: a tube; first and second valve walls mounted to the tube and each having first and second ends, the first and second valve walls converging from their first ends to meet and form a resiliently closable mouth at their second ends, the mouth being openable upon compression of the tube; wherein the first and second valve walls increase in thickness from their first ends to their second ends.

The present invention yet further provides a beverage dispensing container comprising the aforementioned duckbill valve arrangements.

The present invention yet further provides a beverage dispensing container comprising: a beverage reservoir; a container outlet; and a duckbill valve positioned between the beverage reservoir and the container outlet for selectively enabling fluid communication therebetween, the duckbill valve comprising: first and second valve walls converging from first ends to second ends, the second ends being positioned closer to the reservoir than the first ends, and the second ends defining a valve mouth between valve tips.

By way of example only, embodiments of a duckbill valve arrangement are now described with reference to, and as show in, the accompanying drawings.

### BRIEF DESCRIPTION OF THE DRAWINGS

FIG. 1 is a top perspective view of a duckbill valve arrangement of the present invention;

FIG. 2 is a top elevation of the duckbill valve arrangement of FIG. 1;

FIG. 3 is a side elevation of the duckbill valve arrangement of FIG. 1;

FIG. 4 is a cross-sectioned perspective view of a second end of the duckbill valve of all four described embodiments of the present invention;

FIG. 5 is a cross-sectioned perspective view of a first end of the duckbill valve of a first embodiment of the present invention;

FIG. 6 is a cross-sectioned top elevation of the duckbill valve arrangement of FIG. 5;

FIG. 7 is a cross-sectioned perspective view from the second end of the duckbill valve arrangement of FIG. 5;

FIG. 8 is a cross-sectioned perspective view from the first end of the duckbill valve arrangement of FIG. 5;

FIG. 9 is a cross-sectioned perspective view of a first end of the duckbill valve of a second embodiment of the present invention;

FIG. 10 is a cross-sectioned top elevation of the duckbill valve arrangement of FIG. 9;

FIG. 11 is a cross-sectioned perspective view from the second end of the duckbill valve arrangement of FIG. 9;

FIG. 12 is a cross-sectioned perspective view from the first end of the duckbill valve arrangement of FIG. 9;

FIG. 13 is a cross-sectioned perspective view of a first end of the duckbill valve of a third embodiment of the present invention;

FIG. 14 is a cross-sectioned top elevation of the duckbill valve arrangement of FIG. 13;

FIG. 15 is a cross-sectioned perspective view from the second end of the duckbill valve arrangement of FIG. 13;

FIG. 16 is a cross-sectioned perspective view from the first end of the duckbill valve arrangement of FIG. 13;

FIG. 17 is a cross-sectioned perspective view of a first end of the duckbill valve of a fourth embodiment of the present invention;

FIG. 18 is an elevation of the first end of the duckbill valve arrangement of FIG. 17;

FIG. 19 is a cross-sectioned top elevation of the duckbill valve arrangement of FIG. 17;

FIG. 20 is a cross-sectioned perspective view from the second end of the duckbill valve arrangement of FIG. 17;

FIG. 21 is a cross-sectioned perspective view from the first end of the duckbill valve arrangement of FIG. 17;

FIG. 22 is a top perspective view of a duckbill valve arrangement of a fifth embodiment of the present invention;

FIG. 23 is a top perspective view of a duckbill valve arrangement of a sixth embodiment of the present invention; and

FIG. 24 is a schematic view of a beverage dispensing container comprising the duckbill valve arrangement the present invention.

### DETAILED DESCRIPTION

The present invention is generally directed towards a duckbill valve arrangement for a beverage dispensing container comprising a duckbill valve located within a tube. The tube has one or more grooves extending along its outer side. The duckbill valve may have thicker valve tips, indentations in the valve tips and/or supports attaching the valve tips to the tube.

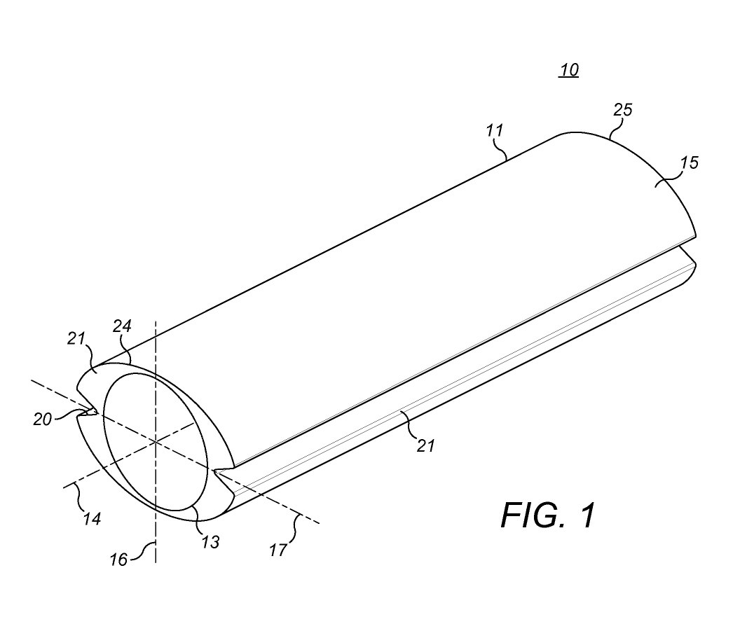

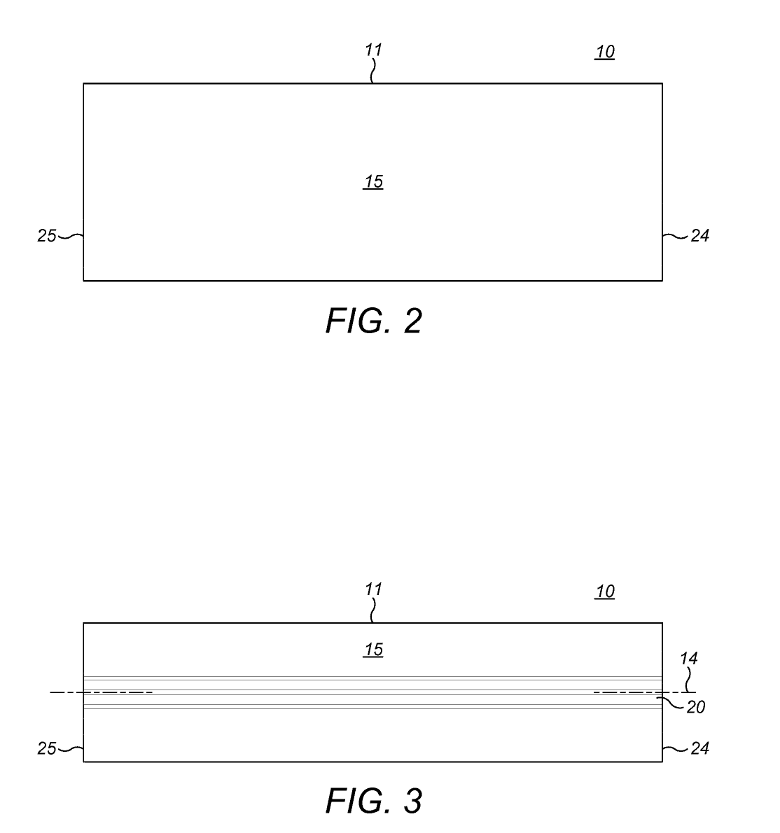

FIGS. 1 to 3 illustrate the duckbill valve arrangement 10 of the present invention. The arrangement 10 comprises a tube 11 having a tube wall 12 defining an internal passageway 13 therein. The tube 11 and passageway 13 extend in a substantially straight manner along a longitudinal axis 14 from a first end 24 to a second end 25. The longest dimension of the tube 11 is its length along the longitudinal axis 14. The passageway 13 has a substantially circular cross-section with a centre point on the longitudinal axis 14.

An outer surface 15 of the tube 11 has a substantially oval cross-section with a centre point on the longitudinal axis 14. As a result, the cross-section of the tube wall 12 is shaped as an annulus having a substantially oval outer edge and a circular inner edge. Thus the tube wall 12 is thinnest where it meets a lateral axis 16 and increases in thickness from the lateral axis 16 towards a transverse axis 17. Such a shape is preferred as the outer oval shape enables the duckbill valve arrangement 10 to be mated correctly within a beverage dispensing container (see below) by matching a correspondingly shaped mounting means in the beverage dispensing container. When an actuator is aligned with the tube 11, the correct alignment of the actuator, i.e. directly over the duckbill valve (see below), can be seen. In addition, the thinner portions of the tube wall 12 enable a more compact arrangement of actuator and tube 11. However, the outer surface 15 of the tube 11 may be any other suitable cross-sectional shape, such as diamond, hexagonal, rectangular or non-rotationally symmetrical.

In this disclosure the lateral and transverse axes 16, 17 are orthogonal to each other in a first plane, the longitudinal and lateral axes 14, 16 are orthogonal to each other in a second plane and the longitudinal and transverse axes 14, 17 are orthogonal to each other in a third plane.

First and second grooves 20, 21 extend along the outer surface 15 of the tube 11 substantially parallel to the longitudinal axis 14. The first and second grooves 20, 21 are positioned to oppose one another in the transverse direction and thus are each located on the tube 11 where the tube wall 12 is at its thickest. The first and second grooves 20, 21 are V-shaped channels in the illustrated embodiments. The advantage of using a “V” shape is that a pivot point is created at the base of the “V” to aid in the compression of the tube 11. However, in other embodiments they may be another suitable shape, such as semi-circular, U-shaped or square shaped.

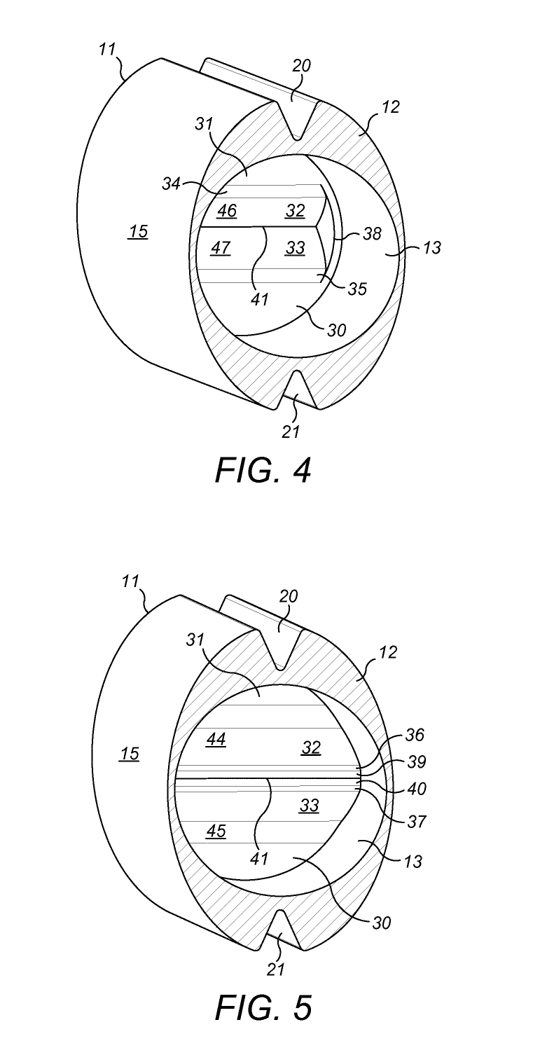

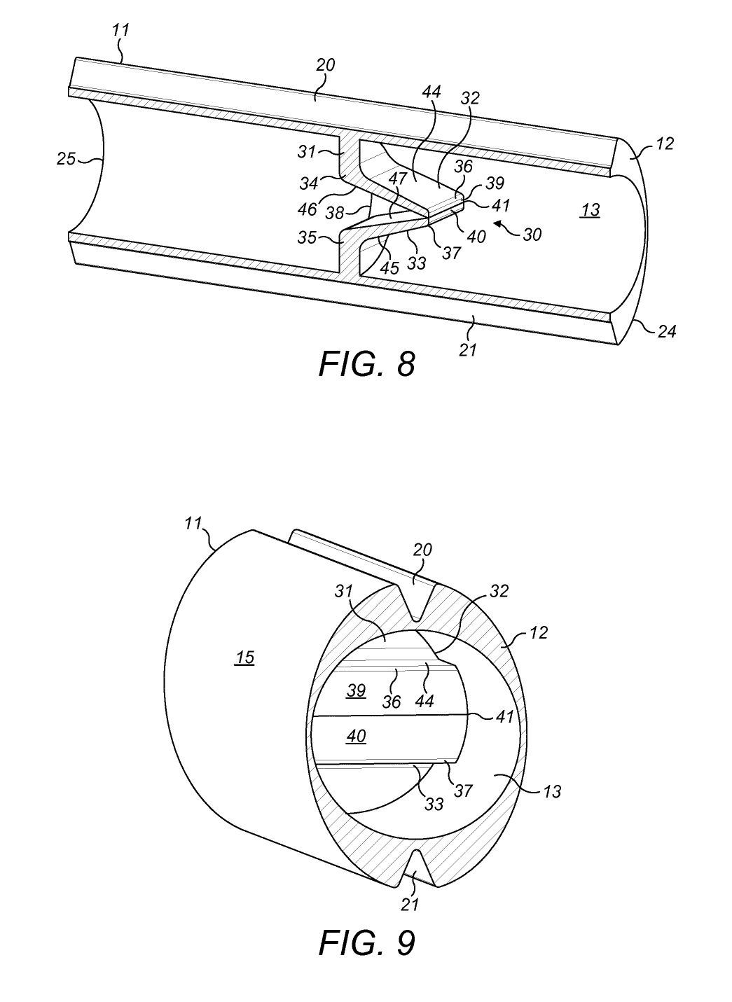

A duckbill valve is mounted within the passageway 13 to selectively enable fluid to flow therethrough. FIGS. 4 to 8 illustrate a first embodiment of a duckbill valve 30 of the present invention. The duckbill valve 30 comprises a mounting wall 31 attached to the inner surface of the tube wall 12 forming the passageway 13. The outer edge of the mounting wall 31 is therefore circular in cross-section.

First and second valve walls 32, 33 extend from the mounting wall 31 at first ends 34, 35 to second ends 36, 37. The first and second valve walls 32, 33 are separated at their first ends 34, 35 by an opening 38 formed in the mounting wall 31. The opening 38 is substantially in the shape of a rectangle with two opposing curved edges. As illustrated, the opening 38 is arranged such that there is a portion of the mounting wall 31 between the tube wall 12 and opening 38 (i.e. the tube wall 12 and opening 38 are separated). However, in other embodiments the curved edges of the opening 38 may be formed by the tube wall 12 itself.

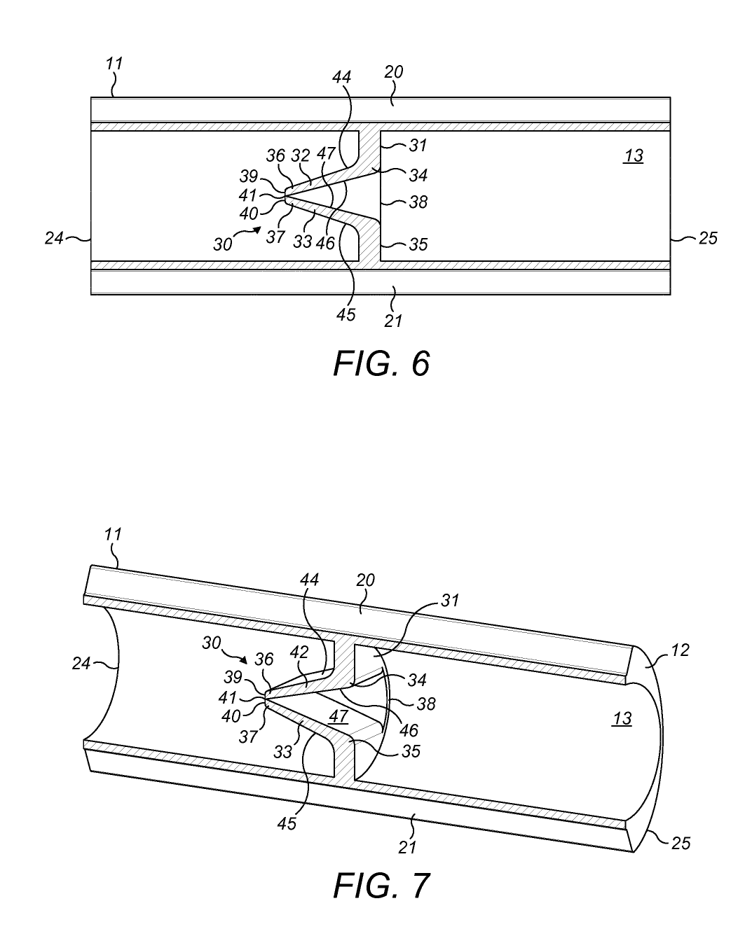

The first and second valve walls 32, 33 converge towards each other from the opening 38 at their first ends 34, 35 and contact each other at their second ends 36, 37. Thus, when viewed in the third plane (i.e. longitudinal-transverse plane) as in FIG. 6, the inner surfaces 44, 45 of the first and second valve walls 32, 33 are at an angle of less than 180° to one another and thereby define a V-shape. The second ends 36, 37 define between valve tips 39, 40 a valve mouth 41 which, when closed, is in the form of an elongate and straight slit. When closed the valve mouth 41 is elongate along the lateral axis 16 such that it extends orthogonal to the longitudinal axis 14 along which the first and second grooves 20, 21 extend. The valve mouth 41 is resiliently biased to be substantially in the closed position, although the valve mouth 41 will not be sealed in such a position until an external pressure is applied to the first and second valve walls 32, 33. When opened the valve mouth 41 is in the shape of an oval or vesica piscis (i.e. oval shaped with pointed ends).

The outer edges of the first and second valve walls 32, 33, i.e. the edges in the transverse direction, are attached to the tube wall 12. Thus fluid can only pass through the valve mouth 41. The largest inner and outer surfaces 44, 45, 46, 47 of the first and second valve walls 32, 33, i.e. those which extend from the first ends 34, 35 to second ends 36, 37 between either side of the tube wall 12, are each substantially flat and planar. The thicknesses of the first and second valve walls 32, 33 are substantially constant or reduce from the first ends 34, 35 to the second ends 36, 37.

The tube 11 and duckbill valve 30 are formed from a resilient (i.e. elastomeric) material such that, after being squeezed or otherwise manipulated, it will return to the aforementioned shape in which the valve mouth 41 is closed. For example, if fluid of a relatively high pressure enters the tube 11 at the second end 25 it will open the valve mouth 41 provided that the fluid on the first end 24 of the tube 11 has a lower pressure. As soon as the pressure equalise at the first and second ends 24, 25 the valve mouth 41 will return to the closed position, although will not be sealed until the pressure at the first end 24 of the tube 11 is greater than the pressure at the second end 25 of the tube 11.

However, in the present invention the valve mouth 41 is openable by squeezing the outer surface 15 of the tube 11. In particular, if a compressive force is provided along the lateral direction (i.e. in the second plane, being the plane along which the valve mouth 41 extends when closed) the valve mouth 41 will open. This is a result of the elastic deformation of the first and second valve walls 32, 33 urging the valve tips 39, 40 away from each other to compensate for the reduced lateral dimension of the duckbill valve 30.

The magnitude of the compression force required to open the valve mouth 41 is substantially reduced by the presence of the first and second grooves 20, 21. If the first and second grooves 20, 21 were not present then, when the tube 11 is compresses, more tension would need to be applied to the tube wall 12 at its thickest points. Thus a relatively smaller compressive force is required due to the first and second grooves 20, 21.

Suitable resilient materials include elastomeric polymers, rubbers, butyl rubber, silicone and thermoplastic elastomers. The material is selected to have a low permeability to oxygen and low degradation to ensure that an effective seal is maintained when the valve mouth 41 is closed.

The duckbill valve arrangement 10 is preferably formed as a single piece by moulding or the like. Preferably the valve mouth 41 is not formed during the moulding and is instead formed afterwards, for example by cutting. Alternatively, the material at the valve mouth 41 may be formed very thin and is subsequently split to form the valve mouth 41 by the application of pressurised fluid. Alternatively, for example, the duckbill valve 30 and tube 11 may be formed separately and subsequently attached to one another.

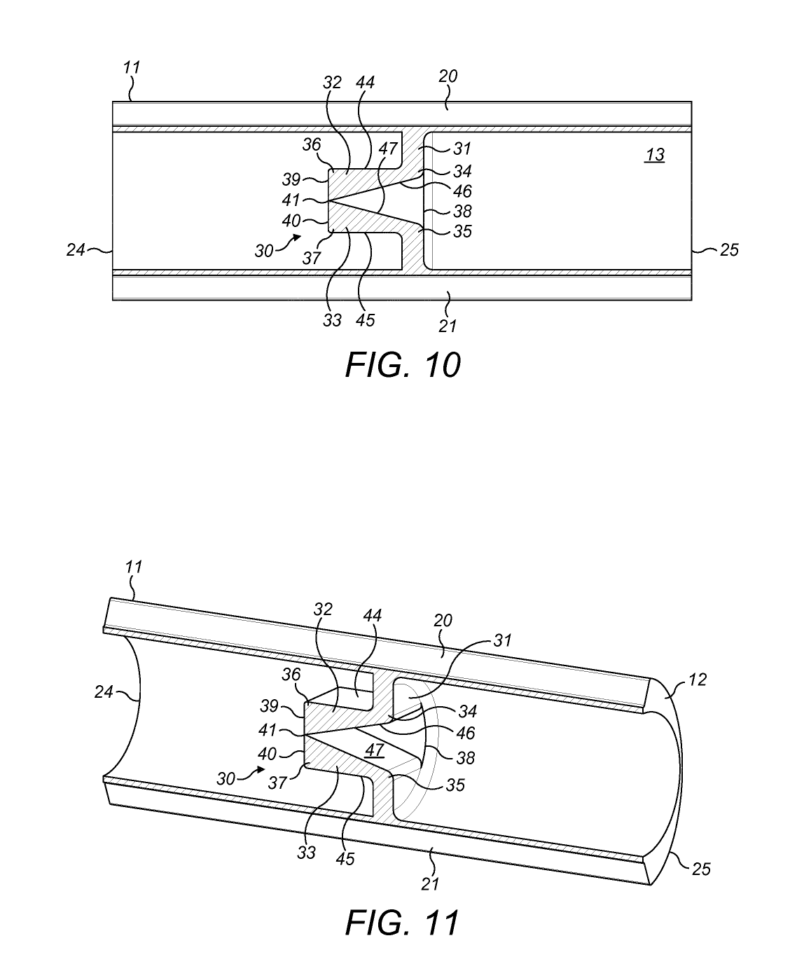

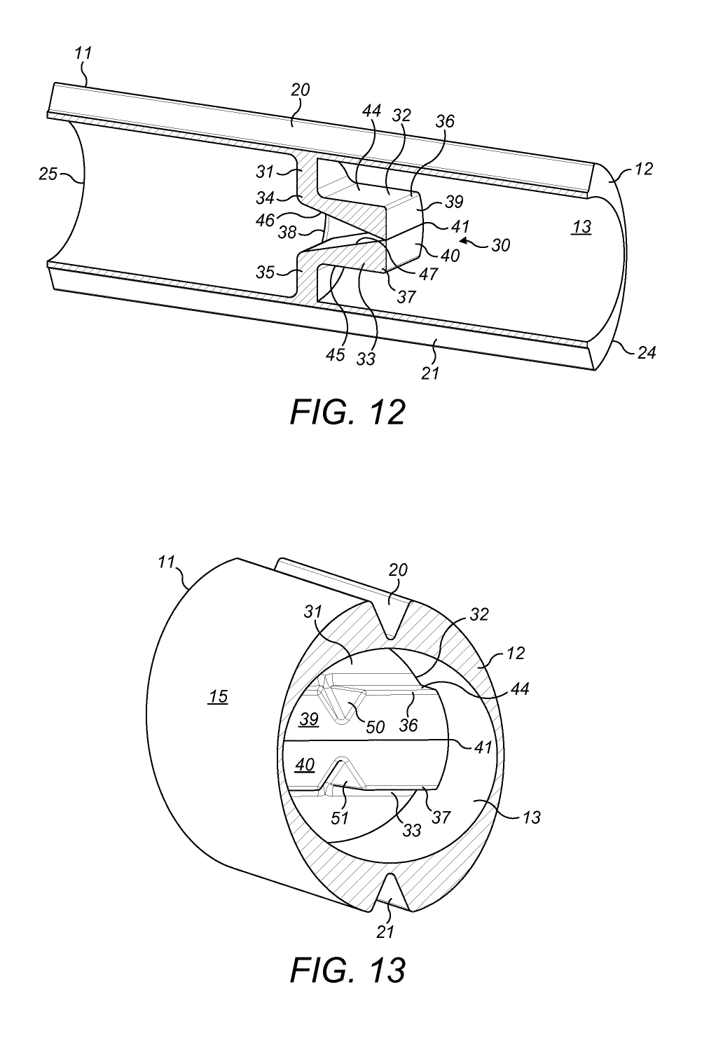

A second embodiment of the duckbill valve 30 is illustrated in FIGS. 9 to 12. The same reference numerals have been used as in FIGS. 1 to 8 as the features are substantially similar to those of the first embodiment. However, the first and second valve walls 32, 33 increase in thickness from their first ends 34, 35 to their second ends 36, 37. The inner surfaces 44, 45 of the first and second valve walls 32, 33 still define a V-shape, but the outer surfaces 46, 47 are substantially parallel to each other. As a result, the first and second valve walls 32, 33 have a rectangular profile and define a substantially rectangular shape when viewed in the third plane (i.e. longitudinal-transverse plane) as in FIG. 10. The valve tips 39, 40 are substantially rectangular with two outwardly curved sides. However, the first and second valve walls 32, 33 may be any other suitable shape, such as convex or triangular.

The benefit of the thicker valve tips 39, 40 is that buckling thereof can be avoided when the compressive force is applied to the tube 11. It was surprisingly found that in the first embodiment both valve tips 39, 40 could curve the same way upon compression such that the valve mouth 41 did not open. By preventing buckling, the valve tips 39, 40 will curve away from one another and thus ensure that the valve mouth 41 opens upon compression of the tube 11.

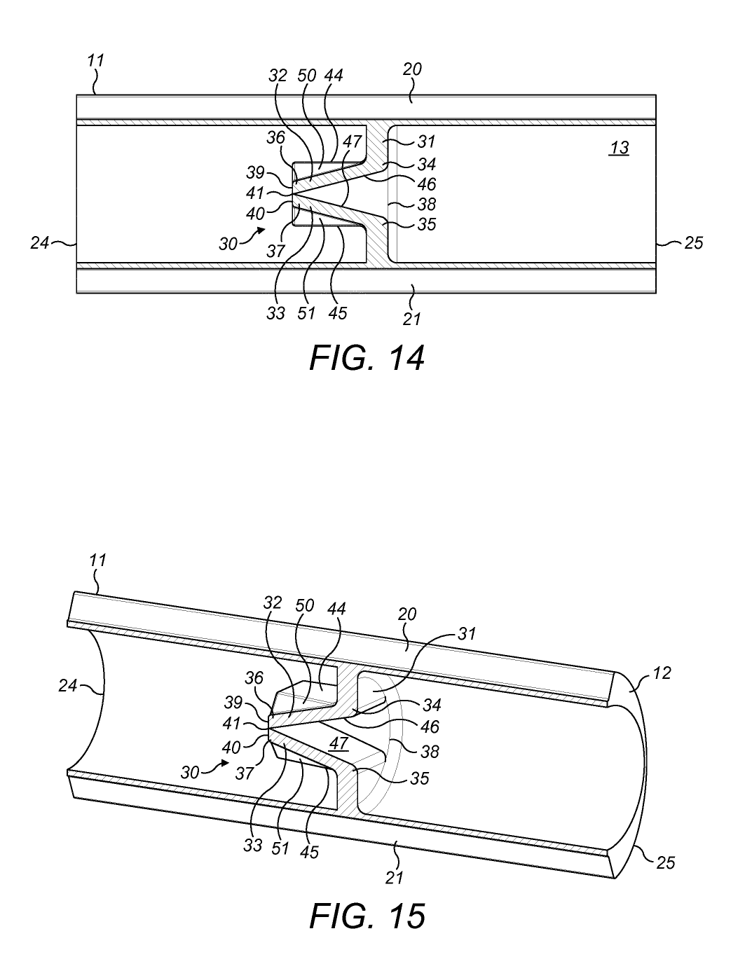

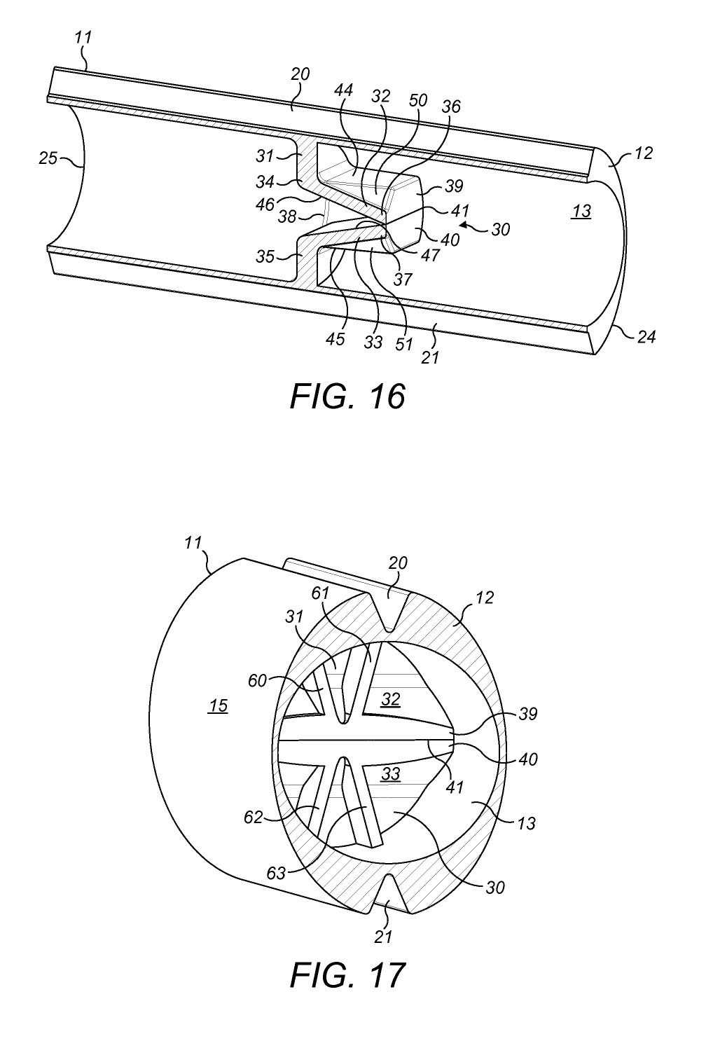

A third embodiment of the duckbill valve 30 of the present invention is illustrated in FIGS. 13 to 16. The same reference numerals have been used as in FIGS. 9 to 12 as the features are substantially similar to those of the second embodiment. The first and second valve walls 32, 33 comprise indentations 50, 51 protruding inwards from the outer surfaces 46, 47 and the valve tips 39, 40. The indentations 50, 51 are located substantially at the centre of the valve tips 39, 40 and extend from the second ends 36, 37 to the first ends 34, 35 of the first and second valve walls 32, 33. The indentations 50, 51 are substantially V-shaped and reduced in depth from the second ends 36, 37 to the first ends 34, 35.

The indentations 50, 51 reduce the force required to open the valve mouth 41 upon compression.

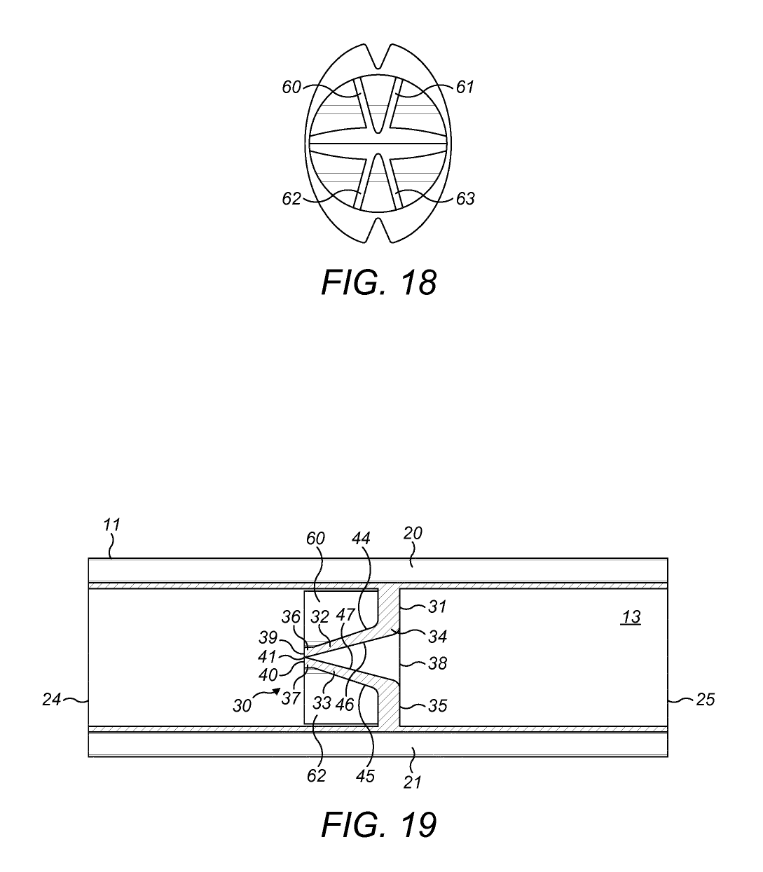

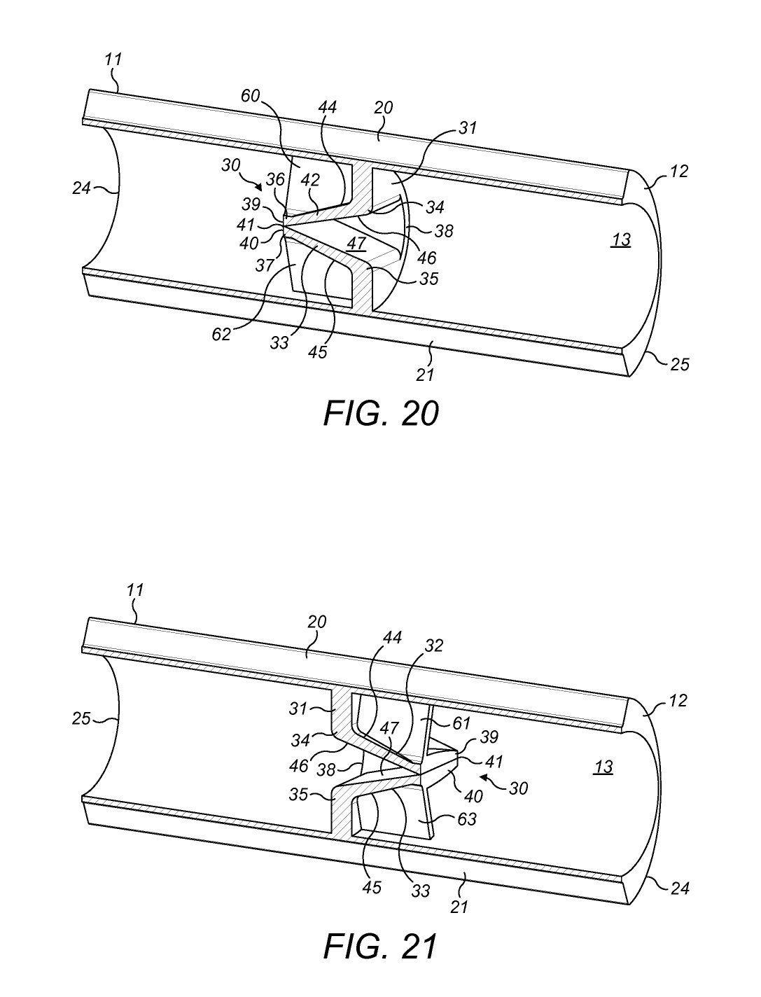

A fourth embodiment of the duckbill valve 30 of the present invention is illustrated in FIGS. 17 to 21. The same reference numerals have been used as in FIGS. 1 to 8 as the features are substantially similar to those of the first embodiment. Supports 60, 61, 62, 63 connect the first and second valve walls 32, 33 to the tube wall 12 such that the valve tips 39, 40 cannot curve towards one another upon compression of the tube 11. Each support 60, 61, 62, 63 comprises a substantially planar and flat wall extending between the mounting wall 31, the outer surfaces 46, 47 of the first and second valve walls 32, 33 and the internal surface of the passageway 13. Two supports 60, 61, 62, 63 are connected to each of the first and second valve walls 32, 33 in a V-shape when the valve is viewed from the first end 24 of the tube 11 (as in FIG. 18). Thus the supports 60, 61, 62, 63 diverge from one another away from the first and second valve walls 32, 33 and towards the tube wall 12. In addition, the outer edges of the valve tips 39, 40 curve outwardly.

The advantage of the supports 60, 61, 62, 63 is that they prevent the valve tips 39, 40 from curving towards each another when the tube 11 is compressed. This ensures that the valve mouth 41 opens upon compression of the tube 11.

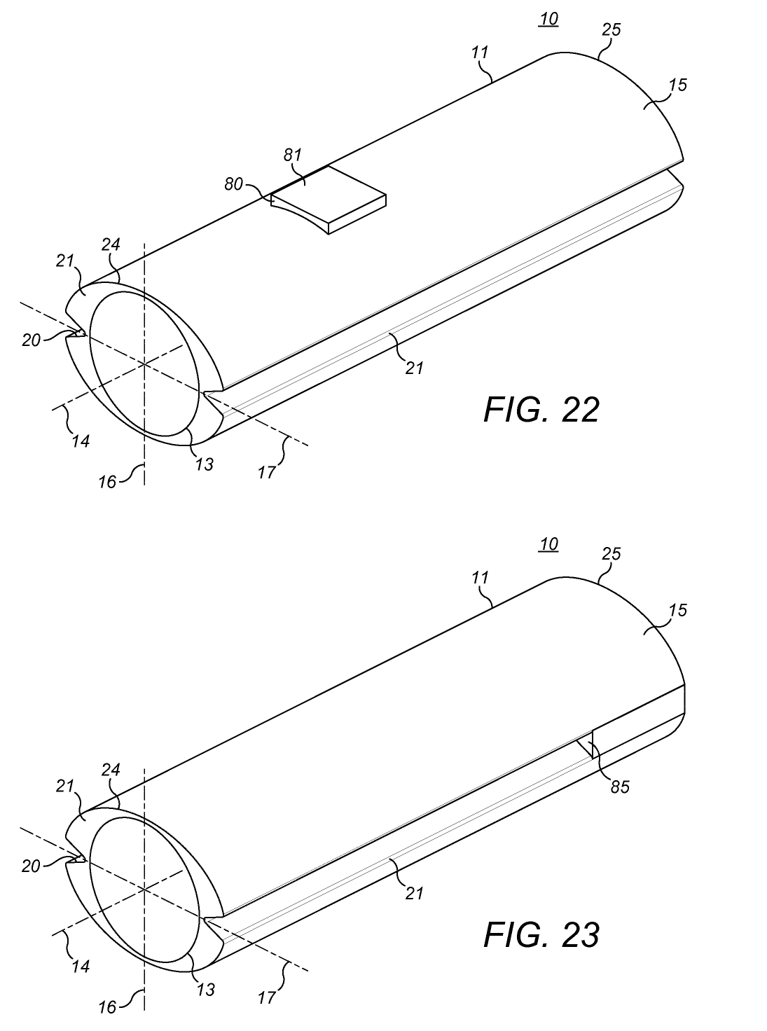

A fifth embodiment of the duckbill valve arrangement 10 is illustrated in FIG. 22. At least one mount 80 is provided on the outer surface 15 of the tube 11 for contact by an actuator (see below) for compressing the tube 11 and opening the duckbill valve 30. Preferably the mount 80 comprises a flat surface, which may be parallel to the third plane, to provide a more suitable contact point for the actuator. In embodiments two mounts 80 are provided in opposed positions on the outer surface 15 of the tube 11, for example where the tube wall 12 is thinnest. Further preferable the at least one mount 80 is aligned with the valve tips 39, 40 of the duckbill valve 30. This ensures that the compression force applied by the actuator is accurately aligned with the valve tips 39, 40, thereby preventing buckling.

A sixth embodiment of the duckbill valve arrangement 10 is illustrated in FIG. 23. At least one of the first and second grooves 20, 21 does not extend all of the way along the tube 11. Instead, a stop 85 is formed in the first and/or second groove 20, 21. Thus the first and second grooves 20, 21 may be used to accurately align the tube 11 by mating with protrusions in a beverage dispensing container and the stop 85 may prevent the tube 11 from sliding too far along the protrusions.

The duckbill valve arrangement 10 having any one of the embodiments of the duckbill valve 30 is particularly suitable for beverage dispensing containers. In particular, the duckbill valve arrangement 10 is suitable where the beverage dispensing container cannot be compressed to eject the fluid.

As illustrated in FIG. 22, a beverage dispensing container 70 comprises the duckbill valve arrangement 10 of any one of the aforementioned embodiments. The duckbill valve arrangement 10 is arranged such that the first end 24 is adjacent to a reservoir outlet 72 from a reservoir 71 of liquid beverage. The second end 25 is arranged adjacent to a container outlet 73 from the beverage dispensing container 70. Thus the valve tips 39, 40 are closest to the reservoir outlet 72.

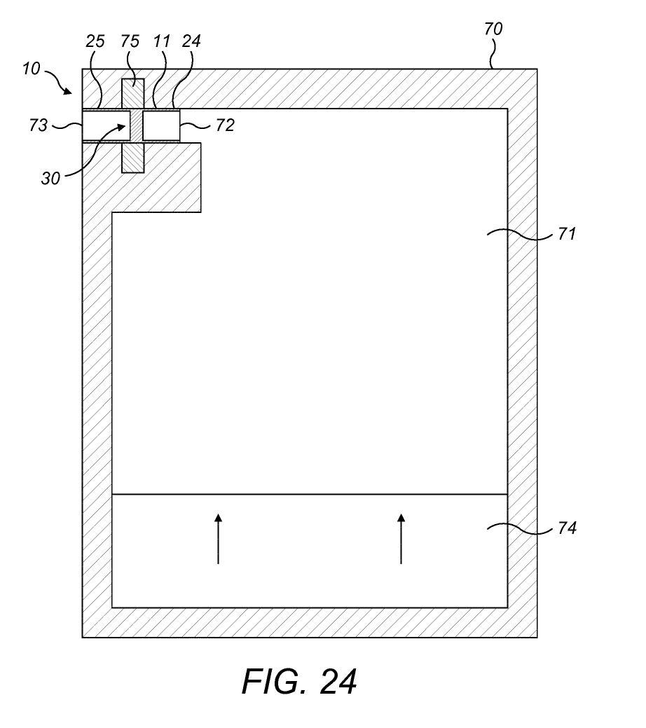

A beverage dispensing arrangement 74 is arranged to compress the liquid against the valve tips 39, 40 of the duckbill valve 30. The beverage dispensing arrangement 74 may comprise a force application means, such as piston and springs, for applying a force (indicated by the arrows in FIG. 24) against a reservoir 71 formed of a flexible membrane. Alternatively, the force application means may comprise a sprung roller which is arranged to roll up the reservoir 71 and thereby apply pressure to the fluid within it. The pressure from the beverage on the valve tips 39, 40 (i.e. an external pressure on the duckbill valve 30) keeps the valve mouth 41 sealed closed.

One or more actuators 75 are provided to supply a compressive force to the tube 11 when beverage is to be dispensed. When the compressive force is applied, the valve mouth 41 opens and fluid flows from the reservoir 71 by virtue of the force from the beverage dispensing arrangement 74. In order to provide the compressive force, the actuator(s) 75 are preferably positioned directly in line with the valve tips 39, 40 and valve mouth 41, such that the compressive force is applied substantially along the slit of the valve mouth 41. This ensures that buckling of the valve tips 39, 40 is avoided.

The first to fourth embodiments have been described with the inclusion of the first and second grooves 20, 21. However, it can be appreciated that the invention may instead comprise a tube without first and second grooves 20, 21 and may be directed instead to the thicker valve tips 39, 40, the indentations 50, 51 and/or the supports 60, 61, 62, 63.

The duckbill valve arrangement 10 is preferably arranged to allow a maximum flow rate of 12 ml/s, but may also be in the range of from 5 ml/s up to 30 ml/s or 50 ml/s. To achieve such flow rates the diameter of the passageway 13 is preferably around 11 mm, but other diameters are suitable, for example in a range of 2 mm to 25 mm. With such dimensions and with a silicone tube it has been found that a suitable compressive force for opening the valve mouth 41 is around 1 to 2 N.

1. A duckbill valve arrangement for a beverage dispensing container, the arrangement comprising:
a tube comprising a resilient tube wall having an outer surface and defining an internal passageway; and
a duckbill valve mounted within the passageway, the duckbill valve comprising a resiliently closable valve mouth arranged to be opened upon compression of the tube;
wherein at least one groove extends along the outer surface of the tube wall for reducing the force required to compress the tube and open the duckbill valve.

2. A duckbill valve arrangement as claimed in claim 1 comprising first and second grooves extending parallel and diametrically opposite to one another along the outer surface of the tube wall.

3. A duckbill valve arrangement as claimed in claim 1 wherein the internal passageway extends along a longitudinal axis and the at least one groove extends parallel to the longitudinal axis.

4. A duckbill valve arrangement as claimed in claim 3 wherein the valve mouth forms a slit when closed, the slit being elongated orthogonal to the longitudinal axis.

5. A duckbill valve arrangement as claimed in claim 1, wherein the tube wall increases in thickness towards the at least one groove.

6. A duckbill valve arrangement as claimed in claim 5 wherein the passageway has a circular cross-section and the outer surface has a substantially oval cross-section and the at least one groove is located on the outer surface where the tube wall is thickest.

7. A duckbill valve arrangement as claimed in claim 1, wherein the duckbill valve comprises resilient first and second valve walls mounted to the tube, the first and second valve walls each having first and second ends and converging from their first ends to meet and form the valve mouth at their second ends.

8. A duckbill valve arrangement as claimed in claim 7 wherein the first and second valve walls increase in thickness from the first to second ends.

9. A duckbill valve arrangement as claimed in claim 8 wherein the outer surfaces of the first and second valve walls have a substantially rectangular side profile.

10. A duckbill valve arrangement as claimed in claim 7, wherein indentations are provided in the outer surfaces of each of the first and second valve walls.

11. A duckbill valve arrangement as claimed in claim 7, wherein supports are provided to attach the second ends of the first and second valve walls to the tube wall.

12. A duckbill valve arrangement as claimed in claim 11 wherein pairs of supports are attached between each of the first and second valve walls and the tube wall, the supports of each pair diverging from one another away from the first and second valve walls.

13. A duckbill valve arrangement for a beverage dispensing container, the arrangement comprising:
a tube;
first and second valve walls mounted to the tube and each having first and second ends, the first and second valve walls converging from their first ends to meet and form a resiliently closable mouth at their second ends, the mouth being openable upon compression of the tube;
wherein the first and second valve walls increase in thickness from their first ends to their second ends.

14. A duckbill valve arrangement as claimed in claim 13 wherein indentations are provided in the outer surfaces of each of the first and second valve walls.

15. A duckbill valve arrangement as claimed in claim 13, wherein supports are provided to attach the second ends of the first and second valve walls to the tube wall.

16. A duckbill valve arrangement as claimed in claim 15 wherein pairs of supports are attached between each of the first and second valve walls and the tube wall, the supports of each pair diverging from one another away from the first and second valve walls.

17. A beverage dispensing container comprising the duckbill valve arrangement of claim 1, for selectively dispensing liquid beverage from a reservoir.

18. A beverage dispensing container as claimed in claim 17 wherein the duckbill valve is arranged to prevent fluid flowing from the reservoir until the tube is compressed such that the valve mouth opens.

19. A beverage dispensing container, said container comprising:
a beverage reservoir;
a container outlet; and
a duckbill valve positioned between the beverage reservoir and the container outlet for selectively enabling fluid communication therebetween, the duckbill valve comprising:
first and second valve walls converging from first ends to second ends, the second ends being positioned closer to the reservoir than the first ends, and the second ends defining a valve mouth between valve tips.

20. A beverage dispensing container as claimed in claim 19 wherein the reservoir contains a beverage and the beverage dispensing container further comprises a beverage dispensing arrangement adapted to apply a pressure to the beverage such that the pressurised beverage in turn applies a pressure to the first and second valve walls and valve tips, and thereby maintains the valve mouth in a closed and sealed position.

21. A beverage dispensing container as claimed in claim 19, further comprising at least one valve actuator to selectively apply a compressive force to the valve tips, so as to open the valve mouth.
